(19) United States
(12) Patent Application Publication
(10) Pub. No.: US 2016/0339916 A1
(43) Pub. Date: Nov. 24, 2016

(54) SYSTEMS AND METHODS FOR SMOOTH DRIVING MODE TRANSITIONS FOR A MOTOR VEHICLE

(71) Applicant: FORD GLOBAL TECHNOLOGIES, LLC, Dearborn, MI (US)

(72) Inventors: Russ Lee NORTON, Brownstown Twp., MI (US); Darrell Erick BUTLER, Macomb, MI (US)

(73) Assignee: FORD GLOBAL TECHNOLOGIES, LLC, Dearborn, MI (US)

(21) Appl. No.: 14/718,541

(22) Filed: May 21, 2015

(51) Int. Cl. B60W 30/182; B60W 10/04; B60W 50/08; B60W 10/10; B60W 10/22; B60W 10/18; B60W 10/20; B60W 30/14

(52) U.S. Cl. CPC B60W 30/182; B60W 10/20; B60W 10/04; B60W 30/14; B60W 10/10; B60W 10/22; B60W 10/18; B60W 50/082; B60W 2050/0014

(57) ABSTRACT

A driving mode system for a motor vehicle includes a controller configured to transition from a first driving mode to a second driving mode by transitioning from the first driving mode to an intermediate driving mode and from the intermediate driving mode to the second driving mode. The controller is further configured to calculate the intermediate driving mode based on values for both the first driving mode and the second driving mode and control the motor vehicle according to the second driving mode. Methods of controlling a driving mode of a motor vehicle and vehicles including a driving mode system are further contemplated.

### TECHNICAL FIELD

The present disclosure relates to systems and methods to smooth transitions between driving modes of a motor vehicle.

### BACKGROUND

Conventional vehicles may include systems that support multiple driving modes, which involve complex algorithms are often required to implement the modes. The algorithms for implementing the driving modes may require large amounts of electronic memory to store and/or implement the various modes. When a control system of such a motor vehicle switches between driving modes, this can feel abrupt and rough to an occupant of the motor vehicle. Thus, conventional driving mode systems for motor vehicles have already contributed to providing various driving modes to improve a driver's experience when operating a motor vehicle, but further improvements may be made to the driving systems to further enhance the experience for a driver of a motor vehicle, such as when transitions occur between driving modes, and to do so with an efficient use of electronic memory.

### SUMMARY

In accordance with one aspect of the present disclosure, a system for controlling a motor vehicle is provided. The system comprises a controller configured to transition between primary driving modes by transitioning from a first primary driving mode to an intermediate driving mode and from the intermediate driving mode to a second primary driving mode, calculate the intermediate driving mode based on values for both the first and second primary driving modes, and control the motor vehicle according to the second primary driving mode.

In accordance with another aspect of the present disclosure, a method of controlling a motor vehicle is provided. The method comprises, with a vehicle controller: calculating at least one intermediate driving mode based on values for first and second primary driving modes, transitioning from the first primary driving mode to the at least one intermediate driving mode and from the at least one intermediate driving mode to the second primary driving mode, and controlling the motor vehicle according to the second primary driving mode.

In accordance with another aspect of the present disclosure, a method of controlling a motor vehicle comprises selecting a primary driving mode, transitioning from a current primary driving mode to the selected primary driving mode, wherein the method of transistioning is dependent upon whether the selected primary driving mode is automatically selected by a controller of the vehicle or selected by user input; and controlling the motor vehicle according to the second primary driving mode.

Additional objects and advantages of the present disclosure will be set forth in part in the description which follows, and in part will be obvious from the description, or may be learned by practice of the present disclosure. Various objects and advantages of the present disclosure will be realized and attained by means of the elements and combinations particularly pointed out in the appended claims.

It is to be understood that both the foregoing general description and the following detailed description are exemplary and explanatory only and are not restrictive of the present disclosure.

The accompanying drawings, which are incorporated in and constitute a part of this specification, illustrate embodiments of the present disclosure and together with the description, serve to explain the principles of the present disclosure.

### BRIEF DESCRIPTION OF THE DRAWINGS

Other advantageous details and effects of the present disclosure are explained in detail below using an exemplary embodiment illustrated in the following figures. In the figures:

FIG. 1 is a side view of a motor vehicle, according to an exemplary embodiment.

FIG. 2 schematically depicts a driving mode system for a motor vehicle, according to an exemplary embodiment of the present disclosure.

FIG. 3 schematically depicts various sensors of a sensing system in communication with a controller, according to an exemplary embodiment of the present disclosure.

FIG. 4 schematically depicts a group of driving modes for a vehicle driving mode system, according to an exemplary embodiment of the present disclosure.

FIG. 5 schematically depicts a method of determining a driving mode for a motor vehicle, according to an exemplary embodiment of the present disclosure.

### DESCRIPTION OF THE EMBODIMENTS

Reference will now be made in detail to various embodiments, examples of which are illustrated in the accompanying drawings. However, these various exemplary embodiments are not intended to limit the disclosure. To the contrary, the disclosure is intended to cover alternatives, modifications, and equivalents. In the drawings and the description, similar elements are provided with similar reference numerals. It is to be noted that the features explained individually in the description can be mutually combined in any technically expedient manner and disclose additional embodiments of the present disclosure.

The various exemplary embodiments described herein contemplate systems and methods for controlling the driving mode of a motor vehicle to facilitate smooth transitions between driving modes of the motor vehicle. As described above, changes between driving modes of a motor vehicle can feel abrupt and rough to an occupant of the motor vehicle, such as when parameters affecting drive feel greatly differ between drive modes. The various exemplary embodiments described herein contemplate, among other things, intermediate driving modes to facilitate smooth transitions between driving modes.

A driving mode system can include a controller and a sensing system, or plurality of sensors, configured to detect or receive data related to various conditions of the motor vehicle. The controller may receive the data from the sensing system and automatically determine a driving mode based upon the data, such as when the controller is an adaptive mode (e.g., automatic), or the controller may control the driving mode based upon a user's input and road conditions. Examples of types of sensor input feedback that may cause the controller to change driving modes include, for example, one or more of traffic information, road state information, safety assessment information, driver state information, and vehicle state information (e.g., vehicle speed, yaw rate, current drive mode, and other vehicle states). The controller is configured to control the motor vehicle according to a selected driving mode. For example, the controller may be in communication with one or more subsystems of the motor vehicle so that the controller may control the subsystems according to the driving mode determined by the controller or according to the driving mode input by the user.

When a driving mode change occurs, the controller is configured to transition from one mode to another by using at least one intermediate driving mode as a means for facilitating a smooth transition between driving modes. For example, in transitioning from a first driving mode to a second driving mode, the controller may be configured to transition from the first driving mode to an intermediate driving mode and from the intermediate driving mode to the second driving mode. The intermediate driving mode may be calculated based upon values of the first and second driving modes, such as by multiplying values assigned to each of the first and second driving modes with a mode constant and summing the results of multiplying the first and second driving modes with the mode constant to determine an intermediate driving mode. The first and second modes may be, for example, primary driving modes (e.g., modes designed for normal driving, comfort, or performance driving), such as primary driving modes determined by using logic (e.g., look up tables, formulas, or other logic). Although the controller may a single intermediate driving mode between a first driving mode and a second driving mode, the controller may use a plurality of intermediate driving modes between the first and second driving modes, such as one, two, three, or more intermediate driving modes. Therefore, a transition between driving modes may be a transition between consecutive intermediate driving modes. The controller may be configured to control how transitions occur between driving modes (e.g., between a first driving mode and an intermediate driving mode, between intermediate driving modes, and/or between an intermediate driving mode and a second driving mode), such as by causing transitions to occur after a predetermined amount of time has elapsed.

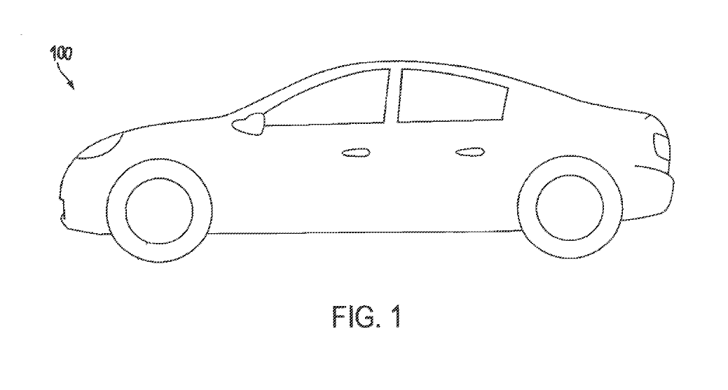

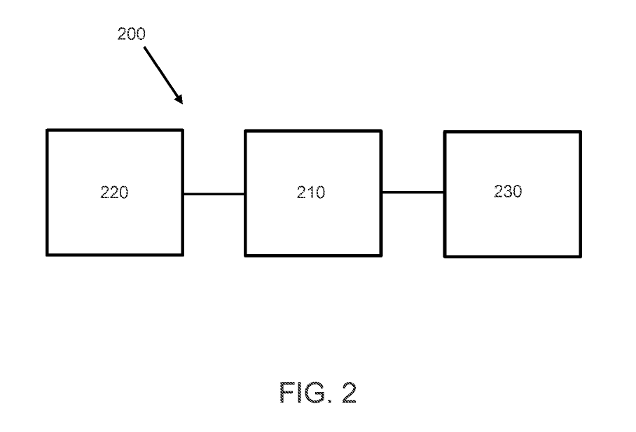

Turning to FIG. 1, a motor vehicle 100 is schematically depicted, according to an exemplary embodiment. Motor vehicle 100 may include a driving mode system 200, schematically depicted in FIG. 2, which is configured to control the driving mode of the motor vehicle 100. Driving mode system 200 may control a driving mode in accordance with input from a user of the vehicle 100 (e.g., according to a driving mode selected by a user of the vehicle) or driving mode system 200 may be configured to automatically select a driving mode for the vehicle 100 (e.g., when the driving mode system is using an adaptive mode to automatically select a driving mode).

When automatically selecting a driving mode (e.g., when in an adaptive mode), driving mode system 200 may base the selection of a driving mode upon one or more conditions related to the motor vehicle 100. For example, driving mode system 200 may include, for example, a controller 210 in signal communication with a sensing system 220, as depicted in the exemplary embodiment of FIG. 2, that detects or receives data for one or more conditions related to motor vehicle 100 that may be used as a basis for the selection of a driving mode. Controller 210 may be in communication with other controller(s) of a vehicle, or may be a part (e.g., section) of a vehicle controller that controls various systems/components of a motor vehicle, besides driving mode system 200.

The configuration of controller 210 is subject to a variety of implementation-specific variations. For example, in some embodiments, the functions described in reference to the controller may be performed across multiple control units or among multiple components of a single controller. Further, the controller may include one or more structural components (e.g., microprocessors) that provide the function of a controller. Any controllers or processors disclosed herein, may include one or more non-transitory, tangible, machine-readable media, such as read-only memory (ROM), random access memory (RAM), solid state memory (e.g., flash memory), floppy diskettes, CD-ROMs, hard drives, universal serial bus (USB) drives, any other computer readable storage medium, or any combination thereof. The storage media may store encoded instructions, such as firmware, that may be executed by a control system or controller to operate the logic or portions of the logic presented in the methods disclosed herein. For example, in certain embodiments, the controller may include computer code disposed on a computer-readable storage medium or a process controller that includes such a computer-readable storage medium. The computer code may include instructions, for example, for controlling components of a brake system actuator, such as controlling a valve of the actuator based on feedback received from another component of the vehicle.

Sensing system 220 may detect or receive data for various conditions associated with the motor vehicle 100, such as vehicle conditions, driver conditions, and/or surrounding conditions of the vehicle 100. According to an exemplary embodiment, sensing system 220 may detect or receive data related to one or more of traffic information, road state information, safety assessment information, driver state information, and vehicle state information (e.g., vehicle speed, yaw rate, current drive mode, and other vehicle states), as described in the exemplary embodiments of U.S. Pat. No. 8,600,614, titled “System and method for integrated control of vehicle control systems,” issued Dec. 3, 2013, which is hereby incorporated by reference in its entirety. According to an exemplary embodiment, sensing system 220 detects or receives data related to at least one of: a current drive mode, ignition status for the vehicle, vehicle speed, whether there is a fault in the selection of a drive mode, and whether the controller 210 is functioning properly.

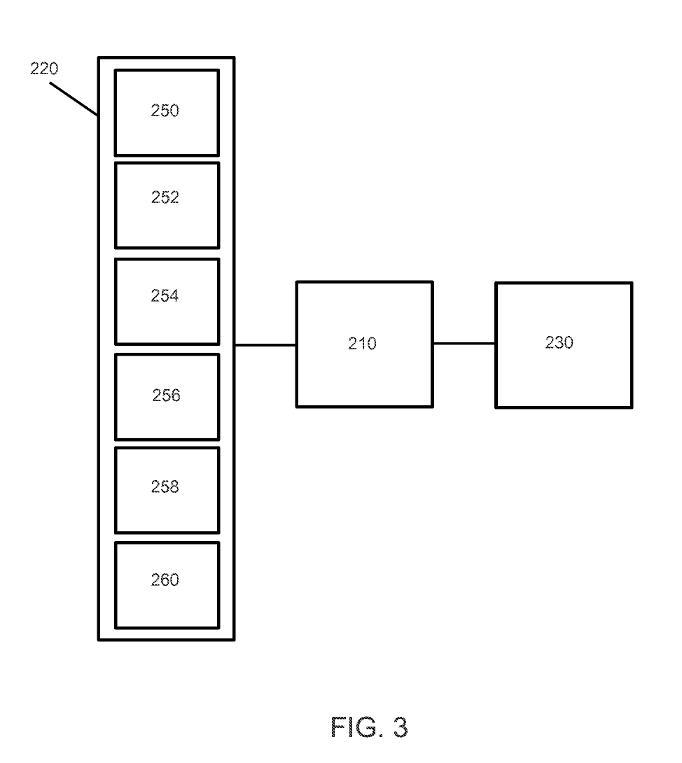

According to an exemplary embodiment, sensing system 220 includes one or more devices 250 to detect or receive data, as depicted in the exemplary embodiment of FIG. 3. For example, sensing system 220 includes one or more devices to detect or receive data related to traffic information (e.g., the volume of traffic), one or more devices 252 to detect or receive data related to a state of a road (e.g., road surface, grade, and/or type of road, such as highway or city road), one or more devices 254 to detect or receive data related to a driver's state, one or more devices 256 to detect or receive data related to safety conditions, one or more devices 258 to detect or receive data related to a vehicle state, and/or one or more devices 260 to detect or receive data related to a current driving mode of the vehicle. The devices used by sensing system 220 may include, for example, wheel speed sensors, yaw rate sensors, antenna, vehicle height sensors, and other sensors familiar to one of ordinary skill in the art.

Data related to safety conditions include, for example, data used to identify a condition or state that may pose safety risks to the passengers in the vehicle. For instance, during high speed driving on a dense traffic area, a sudden switch of powertrain mode, steering mode, etc., might lead to accidents. While driving on snow and icy roads, the vehicle is likely to experience unstable vehicle dynamic conditions that might worsen with switching modes. A driving mode may be selected in view of data related to these safety conditions. In another example, a driving mode transition may be inhibited in order to minimize or prevent the compromise of safety conditions due to switching driving modes. Data related to a vehicle state may include, for example, vehicle information gathered through various sensors, measuring devices, and control modules used in a vehicle. Examples of vehicle state data include speed, wheel alignment, fuel, and tire pressure.

Based upon the data received from sensing system 220, controller 210 may automatically select a driving mode for a motor vehicle 100. Further, as noted above, controller 210 may control a driving mode in accordance with input from a user of the vehicle 100 (e.g., according to a driving mode selected by a user of the vehicle). To facilitate the selection of a driving mode by a user, controller 210 may be configured to output a recommended driving mode to a user (e.g., driver) of a motor vehicle, such as by displaying the recommended driving mode to the user, instead of automatically controlling the driving mode, according to an exemplary embodiment. The user may select a driving mode based on the driving mode recommended by controller 210, select a different driving mode than a driving mode recommended by controller 210, or select a driving mode without receiving a recommended driving mode from controller 210. Controller 210 may include, for example, logic (e.g., look up tables, formulas, and/or other logic) to determine a driving mode, for automatic selection or as a recommendation, based upon data received from sensing system 220.

As depicted in the exemplary embodiment of FIG. 2, controller 210 may be in signal communication with vehicle subsystems 230. Vehicle subsystems 230 may include one or more modules configured to control a particular vehicle subsystem. For example, vehicle subsystems 230 may include one or more modules configured to control one or more of: vehicle power steering, the power train of a vehicle, the adaptive cruise control of a vehicle, the transmission of a vehicle, the suspension of a vehicle, and the brake system of a vehicle, as described in the exemplary embodiments of U.S. Pat. No. 8,600,614. Based upon a driving mode selection input by a user, or based upon a driving mode automatically calculated by controller 210, controller 210 can be configured to issue commands to vehicle subsystems 230 to control the various vehicle subsystems in accordance with the selected driving mode.

Driving mode systems can have various driving modes to provide different experiences for users of a motor vehicle. The driving modes can be primary driving modes, such as, for example, a comfort mode, a normal mode, and a performance or sport mode. For example, the comfort mode can provide a soft suspension feel, the normal mode can provide a standard suspension feel, and the performance mode can provide a firm suspension feel, although other vehicle subsystems can be controlled according to a selected drive mode, as described above.

While the primary modes can provide different experiences for a driver and facilitate use of a motor vehicle, switches between the primary modes can occur while operating a motor vehicle, such as when a driving mode system is operating in an automatic (e.g., adaptive) mode and conditions associated with the vehicle (e.g., data detected or received by sensing system 220) change. Such switches between primary driving modes can feel abrupt to a user of a motor vehicle. Further, the logic of a drive mode system (e.g., controller 210) used to determine a driving mode can be complex and require a large amount of electronic memory. In view of these considerations, it would be desirable to provide driving mode systems configured to control a driving mode and minimize or prevent an uncomfortable feeling for a vehicle user due to a transition between driving modes. Further, it would be desirable to provide driving mode systems that efficiently use the electronic memory of a motor vehicle.

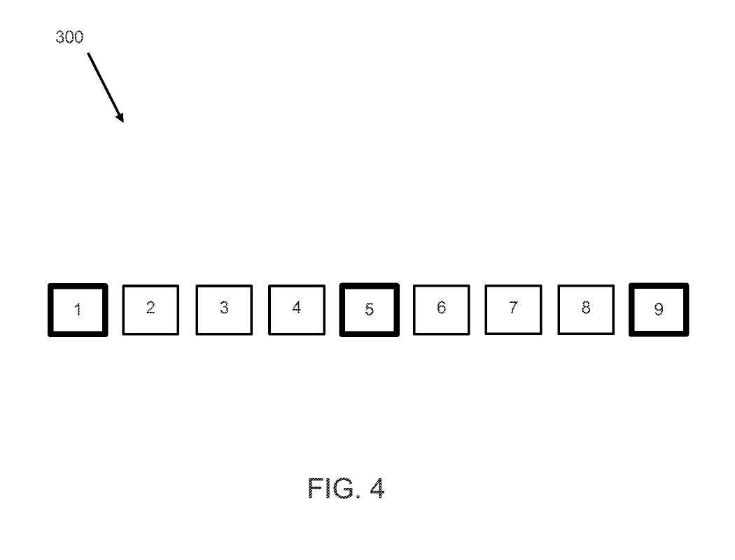

Driving mode systems (e.g., drive mode system 200) of the various exemplary embodiments described herein can be configured to control a driving mode of a motor vehicle from amongst various primary driving modes and intermediate driving modes. Turning to FIG. 4, a group 300 of possible driving modes is depicted for a vehicle having a driving mode system. The group 300 of possible driving modes can be utilized by the various exemplary embodiments described herein. The group 300 can include three primary driving modes 1, 5, and 9. The primary modes can be, for example, a comfort mode (e.g., mode 1), a normal mode (e.g., mode 5), and a performance or sport mode (e.g., mode 9), or other types of driving modes familiar to one of ordinary skill in the art. According to an exemplary embodiment, the driving system uses a default drive mode, such as primary mode 5, when a fault occurs.

During operation of a motor vehicle, a driving mode may switch from one primary mode to another, such as from one of primary modes 1, 5, and 9 to another of primary modes 1, 5, and 9. This may occur due to a driver selecting a new driving mode or due to the driving system selecting a new mode in view of changes of one or more conditions associated with the motor vehicle. Switching directly from one of primary modes 1, 5, and 9 to another could seem abrupt for a user of a motor vehicle and create an uncomfortable feeling for the user.

In view of these considerations concerning transitions between primary modes, driving systems of the various exemplary embodiments described herein may use intermediate modes. As depicted in the exemplary embodiment of FIG. 4, the group 300 of driving modes can include intermediate modes 2, 3, 4, 6, 7, 8. Thus, three intermediate modes (modes 2, 3, 4) are available between primary modes 1 and 5 and three intermediate modes (modes 6, 7, 8) are available between primary modes 5 and 9. Although three intermediate modes are used between each primary mode, the present disclosure contemplates other numbers of intermediate modes between primary modes, such as, for example, one, two, three, four, five, six or more intermediate modes. According to an exemplary embodiment, a transition between primary modes 1 and 9 would include modes 2-8 (e.g., a transitioning from primary mode 1 to intermediate mode 2, from intermediate mode 2 to intermediate mode 3, and so on).

Driving modes (e.g., primary modes and/or intermediate modes) may be variable. Each of the primary modes 1, 5, 9 may be generated by using existing logic (e.g., controller 210 using look up tables, formulas, and/or other logic) using received data related to various conditions associated with a motor vehicle (e.g., data received from sensing system 220). Thus, the primary modes 1, 5, 9 may be determined based upon received data and logic, which can be complex and use a significant amount of electronic memory for each primary mode. To facilitate an efficient use of electronic memory, intermediate modes may be determined on the basis of logic that utilizes a small amount of electronic memory. According to an exemplary embodiment, an intermediate mode (e.g., modes 2, 3, 4, 6, 7, 8) may be calculated as fractions or percentages of primary modes (e.g., modes 1, 5, 9), such as fractions or percentages of primary modes that a driving mode is being switched between. For example, an intermediate mode between a first primary mode and a second primary mode may be calculated as the sum of a fraction of the first primary mode (e.g., generated by using logic) and a fraction of the second primary mode (e.g., generated by using logic). Thus, intermediate modes can blend the values of the primary modes and smooth transitions between primary driving modes.

Further, because intermediate modes may be calculated as fractions or percentages of primary modes, formulas requiring little electronic memory may be used to calculate the intermediate modes. According to an exemplary embodiment, an intermediate mode may be calculated by using a mode constant assigned to the intermediate mode. The mode constant may be predetermined value stored in an electronic memory accessible to the controller. According to an exemplary embodiment, each driving mode (e.g., each driving mode of group 300) may have a predetermined mode constant stored in the electronic memory.

A mode constant may use, for example, about 4 bytes of electronic memory. In comparison, logic for a look up table used to generate a primary mode may use, for example, about 64 bytes per look up table. A separate look up table would need to be prepared for each vehicle subsystem (e.g., vehicle subsystems 230) in order to provide a driving mode value tailored for each subsystem. For instance, conventional systems use about 2000 to about 4000 bytes of memory. In particular, if separate look up tables were needed for ten vehicle subsystems, the amount of memory required for the look up tables accumulates to about 2560 bytes (e.g., 4 intermediate modes each using a look up table of 64 bytes, and a look up table for each of the 10 subsystems). Conversely, the use of a mode constant to calculate an intermediate mode requires about 240 bytes for the constants (e.g., 6 intermediate modes each using a constant of 4 bytes, and a constant for each of the 10 subsystems). Other amounts of memory could be used for the various types of information contemplated by the present disclosure. For example, a mode constant may use, for example, about 3-5 bytes of electronic memory could be used for a mode constant and different numbers of modes, such as intermediate modes, and various numbers of subsystems could be controlled, which in turn provide varying amounts of electronic memory usage. Thus, calculating an intermediate driving mode by using a mode constant provides an efficient use of electronic memory. In addition, a vehicle using such intermediate modes is simpler to set up because manufacturing personnel do not need to create and tune logic (e.g., look up tables, formulas, or other complex logic) for each intermediate mode.

As noted above, an intermediate mode may be calculated according to the following formula by using a constant assigned to the intermediate mode:

Mode value=(mode constant×first mode)+((1−mode constant)×second mode) (1)

In the exemplary embodiment of FIG. 4, intermediate modes 2, 3, 4 can be calculated as follows:

Intermediate mode value=(mode constant×primary mode 1 value)+((1−mode constant)×primary mode 5 value) (2)

Similarly, intermediate modes 6, 7, 8 of FIG. 4 can be calculated as follows:

Intermediate mode value=(mode constant×primary mode 5 value)+((1−mode constant)×primary mode 9 value) (3)

For illustrative purposes, a mode constant may be 0.60 (representing 60%). The mode constant could be used to calculate an intermediate mode (e.g., intermediate mode 3) according to equation 2 above, such as by multiplying a first primary mode value (e.g. a primary mode value calculated based on data received from sensing system 220 and logic used by controller 210) by the mode constant (i.e., first primary mode value x 0.60), multiplying a second primary mode value (calculated similarly to the first primary mode value but using logic for the second primary mode) by one minus the mode constant (i.e., second primary mode value x (1-0.60)), and summing the products.

The mode constants may be predetermined and stored in electronic memory in order to blend values of primary modes and smooth transitions between primary modes. The present disclosure contemplates mode constants having values of, for example, 0 to 1. According to an exemplary embodiment, the intermediate modes may be assigned a value within the following exemplary ranges:

Mode constant for mode 2=about 70% to about 90%

Mode constant for mode 3=about 50% to about 70%

Mode constant for mode 4=about 30% to about 50%

Mode constant for mode 6=about 65% to about 85%

Mode constant for mode 7=about 45% to about 65%

Mode constant for mode 8=about 15% to about 35%

According to an exemplary embodiment, the intermediate modes may be assigned a value, such as, for example, the following :

Mode constant for mode 2=about 80%

Mode constant for mode 3=about 60%

Mode constant for mode 4=about 40%

Mode constant for mode 6=about 75%

Mode constant for mode 7=about 55%

Mode constant for mode 8=about 25%

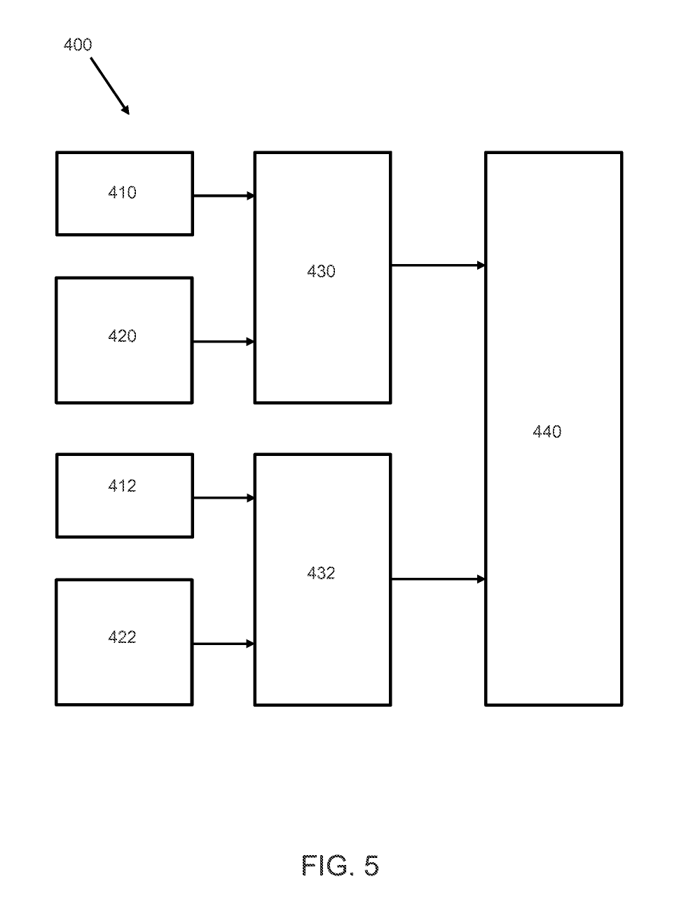

Results of equations 1, 2, and 3 above can be used by a vehicle driving mode system (e.g., controller 210) to control vehicle subsystems (e.g., subsystems 230) according to the calculated driving mode values. FIG. 5 illustrates an exemplary method 400 for calculating a driving mode value for a motor vehicle. For example, method 400 may be used to calculate an intermediate mode value falling between two primary modes (e.g., between primary modes 1 and 5 or between primary modes 5 and 9). In step 410, a mode constant for an intermediate mode (e.g., intermediate mode 2, 4, 5, 6, 7, 8) stored in electronic memory is accessed by a controller (e.g., controller 210 of FIG. 2). In step 420 a value of a first primary mode (e.g., one of primary modes 1, 5, 9) is calculated using logic accessible by the controller (e.g., using one or more look up tables, formulas, and/or other logic for the first primary mode). The logic used in step 420 to calculate the value of the first primary mode in step 420 may use data for various conditions associated with the motor vehicle (e.g., data received from sensing system 220) as input values, according to an exemplary embodiment. In step 430, the controller multiples the value of the first primary mode by the mode constant. In step 412, the mode constant used in step 410 is subtracted from one (i.e., 1—mode constant) and in step 422 a value of the second primary mode (e.g., a remaining one of primary modes 1, 5, 9 and not calculated in step 410) is calculated (e.g., using one or more look up tables, formulas, and/or other logic for the second primary mode). Similarly to step 420, the logic used in step 422 may use data for various conditions associated with the motor vehicle (e.g., data received from sensing system 220) as input values, according to an exemplary embodiment. In step 432, the product of step 412 is multiplied by the value of the second primary mode. In step 440, the controller sums the products of steps 430 and 432 to produce a mode value, such as according to the exemplary equations 1, 2, 3 described above.

The mode value calculated by method 400 may be used by controller 210 to control vehicle subsystems 230, as described above. According to an exemplary embodiment, method 400 may be carried out for each vehicle subsystem so the mode value calculated by method 400 is tailored to each vehicle subsystem. For example, a controller may have access to various types of logic in steps 420 and 422, with each type of logic tuned to the configuration of a subsystem (e.g., tuned to vehicle power steering, the power train of a vehicle, the adaptive cruise control of a vehicle, the transmission of a vehicle, the suspension of a vehicle, or the brake system of a vehicle). As a result, method 400 may provide various mode values that are each tailored for controlling a particular subsystem.

The method 400 of FIG. 5 may also be used to calculate a primary driving mode (e.g., primary mode 1, 5, 9). For example, the mode constant used in step 410 for a primary mode may have a value of one. In other words, a primary mode can have a mode constant of 100%. Thus, the mode constant for each of modes 1, 5, and 9 can have a value of one. As a result, the sum of step 440 equals the value calculated in step 420 because the result of step 412 is zero and the product of step 432 is also zero.

The present disclosure further contemplates rules or protocols to follow when switching driving modes, such as between primary or adaptive driving modes. For instance, a driving mode may be switched by only one consecutive driving mode at time (e.g., consecutive driving modes of group 300). According to an exemplary embodiment, when a vehicle is an adaptive (e.g., automatic) mode and a controller (e.g., controller 210) is selecting a vehicle driving mode, the vehicle driving mode may change only by an increment of one. Thus, when the driving mode is changing from primary mode 1 to primary mode 5, the driving mode must change from primary mode 1 to intermediate mode 2, from intermediate mode 2 to intermediate mode 3, from intermediate mode 3 to intermediate mode 4, and from intermediate mode 4 to primary mode 5. Such incremental changes made be made in reverse from primary mode 5 to primary mode 1. Similar changes may be made between primary modes 5 and 9. When a driving mode transition is made, the new, subsequent driving mode may be calculated based on the exemplary embodiments described herein, such as method 400 of FIG. 5. Such incremental changes in driving mode facilitate smooth transitions between driving mode and minimizing discomfort for users of a motor vehicle.

According to an exemplary embodiment, a predetermined amount of time may be required before a driving mode may transition from one driving mode to another. For instance, a controller (e.g., controller 210) may begin a timer once a driving mode has changed and delay changing the driving mode again until a predetermined amount of time has occurred. Delaying a change in driving mode may facilitate smooth driving mode transitions by preventing multiple driving transitions from occurring within a short period of time. The period of time may range from, for example, about 10 ms to about 1000 ms. In one example, when the driving mode is changing from primary mode 1 to primary mode 5, the driving mode changes from primary mode 1 to intermediate mode 2, a predetermined period of time occurs before another change, the driving mode changes from intermediate mode 2 to intermediate mode 3, a predetermined period of time occurs before another change, the driving mode changes from intermediate mode 3 to intermediate mode 4, a predetermined period of time occurs before another change, and the driving mode changes from intermediate mode 4 to primary mode 5. Such incremental changes made be made in reverse from primary mode 5 to primary mode 1 and between primary modes 5 and 9. When a driving mode transition is made, the new, subsequent driving mode may be calculated based on the exemplary embodiments described herein, such as method 400 of FIG. 5.

Using incremental changes (changing a driving mode by one consecutive value at a time) and using a predetermined amount of time between driving mode changes may be used, for example, when the controller is using an adaptive (e.g., automatic) mode and the controller determines the driving mode should change. Further, when a vehicle user has been selecting a driving mode but then activates the adaptive mode of the controller, which subsequently determines that the driving mode should change, the incremental changes and predetermined amounts of time between changes may be used once the adaptive mode is engaged.

The present disclosure contemplates driving mode changes when control of driving modes is switched from a driving mode selected by the controller (e.g., during the adaptive mode) to a driving mode selected by a user of a motor vehicle. When control is switched from the adaptive mode of the controller to a driving mode selected by a user of a motor vehicle, the transition to the driving mode selected by the user is made as fast as possible, according to an exemplary embodiment. For example, when a controller is in the adaptive mode of control and the driving mode is currently primary mode 9, such as according to conditions data detected or received by sensors (e.g., sensing system 220), but a user selects primary mode 1 as the driving mode, the driving mode is switched from primary mode 9 to primary mode 1 without using any intermediate mode or primary mode in between. When the driving mode transition is made, the new, subsequent driving mode may be calculated based on the exemplary embodiments described herein, such as method 400 of FIG. 5. Further, the transition between the driving modes may be made without delaying a predetermined amount of time, as discussed above.

The present disclosure further contemplates a protocol for when a fault occurs during the adaptive mode operation of a controller, such as when the controller does not receive sufficient information (e.g., from sensing system 220) to determine a driving mode. When such a fault occurs, the controller may use a predetermined default driving mode, such as, for example, a primary driving mode. For instance, primary driving mode 5 may be used as a predetermined default driving mode that is used when a fault occurs during the adaptive driving mode of a controller. As described above, each driving mode may be assigned a predetermined mode constant that is stored in electronic memory. For example, a mode may be listed in the electronic memory and assigned a mode constant so that when a driving mode system determines that a transition should be made to a particular driving mode, the driving mode system (e.g., controller 210) accesses the electronic memory, looks up the particular driving mode (e.g., primary mode 1), and uses the mode constant stored in the electronic memory for the particular driving mode to determine a driving mode (e.g., according to method 400). According to an exemplary embodiment, the mode used as the predetermined default driving mode is not listed in the electronic memory under as itself but is instead provided under the listing for the default mode. For example, if primary driving mode 5 is used as the default mode, no listing is provided in the electronic memory for “driving mode 5.” However, the listing in the electronic memory for the “default” would include the mode constant for driving mode 5. As a result, when a fault occurs, the driving mode system would access the listing for the default mode, which has the value for mode 5. Further, when the driving mode system requires the mode constant for mode 5, the system would access the memory but not find a listing for mode 5, but this would result in the mode using the default value, which is the value for mode 5, because no matching listing could be found. As a result, a robust system is provided for determining driving mode values for a driving mode system.

Transitions to the predetermined default driving mode may use intermediate modes, such as by incrementally changing to a consecutive intermediate mode, as discussed above. Further, a predetermined amount of time may be used to delay transitions between driving modes. According to one example, the driving mode may be primary mode 9 in an adaptive mode of a controller when a fault occurs. The driving mode may transition from primary mode 9 to intermediate mode 8, from intermediate mode 8 to intermediate mode 7, from intermediate mode 7 to intermediate mode 6, and from intermediate mode 6 to primary mode 5, which is the default mode. Further, each driving mode transition may occur after a predetermined amount of time has occurred. When a driving mode transition is made, the new, subsequent driving mode may be calculated based on the exemplary embodiments described herein, such as method 400 of FIG. 5.

The present disclosure contemplates using intermediate modes as transitions between primary driving modes to facilitate the smoothness of the transitions. The present disclosure further contemplates using an intermediate mode as for an indefinite period of time. For example, if a controller (e.g., controller 210) determines that an intermediate mode (e.g., mode 2, 3, 4, 6, 7, 8) provides the most suitable driving mode (e.g., using method 400), such as based upon various conditions associated with a motor vehicle (e.g., data for conditions detected or received by sensing system 220), the controller may maintain the intermediate mode as a driving mode for an indefinite period of time. According to an exemplary embodiment, a controller may maintain an intermediate mode as the driving mode until the controller determines (e.g., when the controller is in the adaptive mode) that another driving mode provides a better driving mode, such as based upon various conditions associated with the motor vehicle, when a user selects a different driving mode, or when a fault occurs.

Further modifications and alternative embodiments will be apparent to those of ordinary skill in the art in view of the disclosure herein. For example, the systems and the methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the spirit and scope of the present teachings and following claims.

This description and the accompanying drawing that illustrates exemplary embodiments of the present teachings should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated features that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “a sensor” includes two or more different sensors. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the system and method of the present disclosure without departing from the scope its disclosure. It is to be understood that the particular examples and embodiments set forth herein are non-limiting, and modifications to structure, dimensions, materials, and methodologies may be made without departing from the scope of the present teachings. Other embodiments of the disclosure will be apparent to those skilled in the art from consideration of the specification and practice of the disclosure disclosed herein. It is intended that the specification and embodiment described herein be considered as exemplary only.

What is claimed:

1. A system for controlling a motor vehicle, comprising:
a controller configured to:
transition between primary driving modes by transitioning from a first primary driving mode to an intermediate driving mode and from the intermediate driving mode to a second primary driving mode;
calculate the intermediate driving mode based on values for both the first and second primary driving modes; and
control the motor vehicle according to the second primary driving mode.

2. The system of claim 1, wherein the controller is configured to calculate the first and second primary driving modes using logic stored in electronic memory accessible by the controller and based on data for one or more conditions associated with the motor vehicle.

3. The system of claim 1, wherein the controller is configured to calculate the intermediate driving mode by multiplying each of the first and second primary driving modes by a predetermined constant stored in electronic memory accessible to the controller and summing results of multiplying each of the first and second primary driving modes by the predetermined constant.

4. The system of claim 1, wherein the controller is configured to use at least two intermediate driving modes when transitioning from the first primary driving mode to the second primary driving mode.

5. The system of claim 4, wherein the at least two intermediate driving modes are consecutive interemediate driving modes from an available group of intermediate driving modes between the first and second primary driving modes.

6. The system of claim 4, wherein the controller is configured to transition from one intermediate driving mode to another intermediate driving mode after a predetermined amount of time has occurred between each driving mode transition.

7. The system of claim 1, further comprising a sensing system configured to detect or receive data for one or more conditions associated with the motor vehicle, wherein the controller is in signal communication with the sensing system and is configured to receive the data from the sensing system.

8. The system of claim 7, wherein, when the controller is in an adaptive control mode, the controller is configured to automatically determine the second primary driving mode for the motor vehicle based the data received from the sensing system.

9. The system of claim 7, wherein, when the transition from the first primary driving mode to the second primary driving mode is based on input by a user of the motor vehicle to select the second primary driving mode, the controller is further configured to transition directly from the first primary driving mode to the second primary driving mode without using an intermediate driving mode.

10. The system of claim 7, wherein the controller is configured to transition to a predetermined default primary driving mode when a fault occurs with the controller.

11. The system of claim 7, wherein the sensing system is configured to detect or receive data related to one or more of traffic information, road state information, safety assessment information, driver state information, and vehicle state information

12. The system of claim 1, wherein the controller is configured to be in signal communication with one or more vehicle subsystems of the motor vehicle in order to control the one or more vehicle subsystems according to the second primary driving mode of the motor vehicle.

13. The system of claim 12, wherein the subsystems of the motor vehicle include one or more of power steering of the motor vehicle, a power train of the motor vehicle, an adaptive cruise control of the motor vehicle, a transmission of the motor vehicle, a suspension of the motor vehicle, and a brake system of the motor vehicle.

14. A method of controlling a motor vehicle, comprising:
with a vehicle controller:
calculating at least one intermediate driving mode based on values for first and second primary driving modes;
transitioning from the first primary driving mode to the at least one intermediate driving mode and from the at least one intermediate driving mode to the second primary driving mode; and
controlling the motor vehicle according to the second primary driving mode.

15. The method of claim 14, wherein the values for the first primary driving mode and the second primary driving mode are calculated using logic stored in electronic memory and based on data for one or more conditions associated with the motor vehicle.

16. The method of claim 14, wherein calculating the at least one intermediate driving mode comprises multiplying each of the first and second primary driving modes by a predetermined constant stored in electronic memory and summing results of multiplying each of the first and second driving modes by the predetermined constant.

17. The method of claim 14, wherein transitioning between modes comprises using at least two intermediate driving modes when transitioning from the first primary driving mode to the second primary driving mode.

18. The method of claim 14, wherein transitioning between modes comprises transitioning from one mode to another mode after a predetermined amount of time has occurred between each driving mode transition.

19. The method of claim 14, further comprising:
receiving data one or more conditions associated with the motor vehicle from a sensing system; and
calculating the values for the first primary driving mode and the second primary driving mode based on the received data.

20. A method of controlling a motor vehicle, comprising:
selecting a primary driving mode;
transitioning from a current primary driving mode to the selected primary driving mode, wherein the method of transistioning between primary modes is dependent upon whether the selected primary driving mode is automatically selected by a controller of the vehicle or selected by user input; and
controlling the motor vehicle according to the second primary driving mode.

21. The method of claim 20, wherein, when the selected primary driving mode is automatically selected by the controller, the method of transitioning includes:
calculating at least one intermediate driving mode based on values for the first and second primary driving modes; and
transitioning from the first primary driving mode to the at least one intermediate driving mode and from the at least one intermediate driving mode to the second primary driving mode.

22. The method of claim 21, wherein, when the selected primary driving mode is slected by user input, the method of transitioning includes transitioning directly from the first primary driving mode to the second primary driving mode.
